(19) United States
(12) Patent Application Publication
(10) Pub. No.: US 2016/0155092 A1
(43) Pub. Date: Jun. 2, 2016

(54) INTERACTIVE INTERFACE FOR VIEWING QUALIFICATIONS OF PEOPLE MAINTAINED IN AN ENTERPRISE RESOURCE PLANNING (ERP) SYSTEM

(71) Applicant: Oracle International Corporation, Redwood Shores, CA (US)

(72) Inventors: Mudit Gupta, Bangalore (IN); Jeevan Selvan Job John, Bangalore (IN); Veena Vasu, Bangalore (IN); Venkat Ramana Reddy Basireddy, Bangalore (IN); Srinivas Bangalore Ananda Rao, Bangalore (IN); Lakshmi Prasad Mulapalli, Bangalore (IN)

(21) Appl. No.: 14/556,276

(22) Filed: Dec. 1, 2014

(51) Int. Cl. G06Q 10/10

(52) U.S. Cl. CPC G06Q 10/105

(57) ABSTRACT

An aspect of the present disclosure provides a convenient user interface for interactively viewing the qualifications of people maintained in an ERP system. In an embodiment, a group of qualifications are displayed on a display screen. The user then provides identity of a person of interest. Only those of the qualifications possessed by the user are highlighted on the display screen. The user can select a different user to have the corresponding (possessed) qualifications highlighted. According to another aspect of the present disclosure, the user first selects a list of persons of interest. The list of such selected persons are also displayed on a portion of the display screen along with the qualifications in other portions. According to yet another aspect when a displayed qualification is selected, those of the displayed persons possessing the selected qualification are highlighted.

### BACKGROUND OF THE DISCLOSURE

1. Technical Field

The present disclosure relates to enterprise resource planning systems, and more specifically to an interactive interface for viewing qualifications of people maintained in an enterprise resource planning (ERP) system.

2. Related Art

ERP systems are typically designed to facilitate collection, storage, management, interpretation and acting upon complex and voluminous data about an enterprise (e.g., companies, universities). Such data often covers people who are both internal and external to the enterprise. For example, ERPs maintain data about employees of a business, as well as prospective employees (i.e., job applicants) of the business.

In the human resources context, data pertaining to the qualifications of people is important at least in retaining and recruiting people into the business. Qualifications reflect the ability, capability or credentials of a person, which are typically the basis for evaluating the strength or weakness of that person as related to enterprise's requirements. For example, qualifications of a person such as competencies, degree(s), and language skills are examined or measured against the same set of qualifications for another person(s), in order to make a decision on succession planning, retention (e.g., promotion, salary increase) or recruitment (e.g., hiring) of that person.

Interactive interfaces are often provided for viewing qualifications of people maintained in an ERP system. Such interfaces normally facilitate users to enquire qualifications of one or more persons, as suited in the corresponding situation. The information presented as a result generally needs to be easily accessible and easily understandable. It may be desirable that such requirements are met with one or more of displays such as computer monitors, smart-phones, and tablets, which provide different sizes of display areas.

Aspects of the present disclosure provide interactive interfaces for viewing qualifications of people maintained in an ERP system.

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present disclosure can be implemented.

FIG. 2 is a flow chart illustrating the manner in which qualifications of people may be viewed interactively, according to an aspect of the present disclosure.

FIG. 3 illustrates the manner in which qualifications data is maintained in an embodiment of the present disclosure.

FIG. 4A is a screenshot (display on a display screen at a corresponding time instance) illustrating the manner in which a user can select persons and qualification groups of interest and the relevant qualifications are thereafter populated on a display screen in an embodiment.

FIG. 4B is a screenshot illustrating the manner in which the qualifications possessed by a person are highlighted upon selection of the person in an embodiment of the present disclosure.

FIG. 4C is a screenshot illustrating the manner in which persons possessing a qualification are shown highlighted upon selection of the qualification in an embodiment.

FIG. 4D is a screenshot depicting the manner in which the extent to which qualifications are satisfied is depicted graphically, in an embodiment of the present disclosure.

FIG. 4E is a screenshot depicting the manner in which the extent to which qualifications are satisfied is depicted graphically, according to another aspect of the present disclosure.

FIG. 5 is a screenshot depicting the manner in which a user can request additional information of a person in an embodiment of the present disclosure.

FIG. 6 is a screenshot illustrating the additional information for a person is displayed in an embodiment of the present disclosure.

FIG. 7 is a screenshot illustrating the manner in which each person can be placed in a multi-dimensional graph, with the location of a person in each dimension indicating the extent to which the person satisfies the qualifications group represented by the dimension, in an embodiment of the present disclosure.

FIG. 8 is a block diagram illustrating the details of a digital processing system in which several aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure provides a convenient user interface for interactively viewing the qualifications of people maintained in an ERP system. In an embodiment, a group of qualifications are displayed on a display screen. The user then provides identity of a person of interest. Only those of the qualifications possessed by the user are highlighted on the display screen. The user can select a different user to have the corresponding (possessed) qualifications highlighted.

According to another aspect of the present disclosure, the user first selects a list of persons of interest. The list of such selected persons is also displayed on a portion of the display screen along with the qualifications in other portions. When a user is selected from such displayed selected persons, the corresponding qualifications are highlighted on the display screen.

According to yet another aspect when a displayed qualification is selected, those of the displayed persons possessing the selected qualification are highlighted. The display may conveniently depict the extent to which a possessed qualification is satisfied by the specific person.

According to one more aspect of the present disclosure, the user is provided the ability to select multiple groups of qualifications along with multiple persons of interest. A multi-dimensional graph is displayed, with each dimension corresponding to one group of qualifications. A person is placed in the graph such that the location of the person along each dimension represents the extent to which the person satisfies the qualifications of that group.

Due to a combination of such features, qualifications of different persons of interest can be easily viewed and compared.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

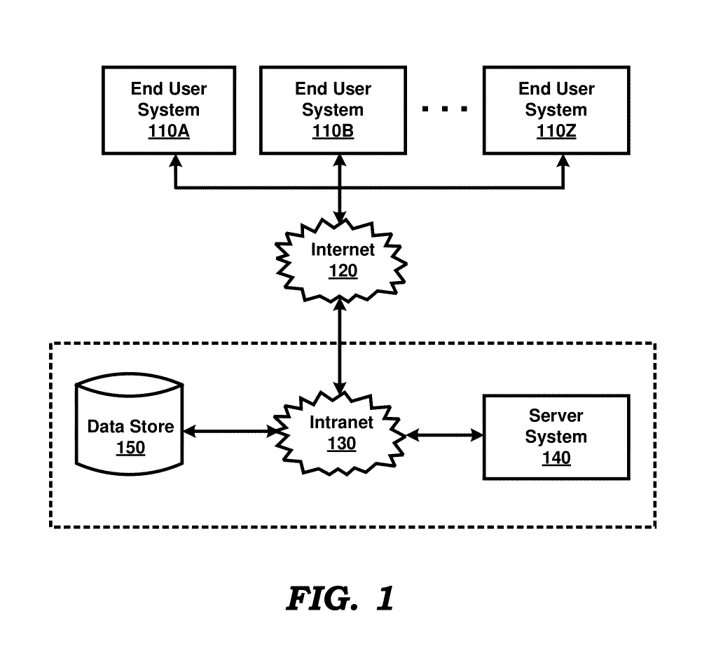

FIG. 1 is a block diagram illustrating an example environment in which several aspects of the present disclosure can be implemented. The block diagram is shown containing end user systems 110A-110Z, Internet 120, intranet 130, server system 140, and data store 150.

Merely for illustration, only representative number/type of systems is shown in the Figure. Many environments often contain many more systems, both in number and type, depending on the purpose for which the environment is designed. Each system/device of FIG. 1 is described below in further detail.

Intranet 130 represents a network providing connectivity between server system 140, and data store 150, all provided within an enterprise (shown with dotted boundaries). Internet 120 extends the connectivity of these (and other systems of the enterprise) with external systems such as end user systems 110A-110Z. Each of intranet 130 and Internet 120 may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the destination system to which the packet is to be eventually delivered.

A (IP) packet is said to be directed to a destination system when the destination IP address of the packet is set to the (IP) address of the destination system, such that the packet is eventually delivered to the destination system by intranet 130 and Internet 120. When the packet contains content such as port numbers, which specifies the destination application, the packet may be said to be directed to such application as well. The destination system may be required to keep the corresponding port numbers available/open, and process the packets with the corresponding destination ports. Each of Internet 120 and intranet 130 may be implemented using any combination of wire-based or wireless mediums.

Data store 150 represents a non-volatile (persistent) storage facilitating storage and retrieval of a collection of data by applications executing in other systems of the enterprise such as server system 140. For example, data store 150 may be implemented to store the qualifications of people, which would be of interest to the end-users operating the end-user systems 110A-110Z.

Therefore, data store 150 may be utilized in facilitating the retrieval of information regarding the people for use with other systems of the enterprise such as server system 140. Data store 150 may be implemented as a database server using relational database technologies and accordingly provide storage and retrieval of data using structured queries such as SQL (Structured Query Language). Alternatively, or in addition, data store 150 may be implemented as a file server providing storage and retrieval of data in the form of files organized as one or more directories, as is well known in the relevant arts.

Server system 140 executes (or hosts) applications that form part of an ERP system. The ERP applications provide user interfaces with which users operating end user systems 110A-110Z interact with the server system 140. The ERP applications may process various data elements stored in data store 150 and the resulting output may be provided to users on user systems 110A-110Z and/or stored again in data store 150.

In particular, server system 140 provided according to aspects of the present disclosure facilitates convenient viewing of qualifications of various people maintained in data store 150. The server system provides various software infra-structure elements for execution of such ERP applications. In an embodiment, the server system is implemented in accordance with “PeopleSoft Human Capital Management”, available from Oracle Corporation.

Each of end user systems 110A-110Z represents a system such as a personal computer, workstation, mobile station, mobile phones, computing tablets, etc., used by users to interact with server system 140. In interacting with server system 140, a user may initiate execution of ERP applications on server system 140 and/or view the output generated by such applications based on appropriate user interfaces. In particular, users at end user systems may view qualifications of various persons received from server system 140 based on suitable user interfaces provided according to aspects of the present disclosure, as described below with examples.

### 3. Interactive Interfaces for Viewing Qualifications

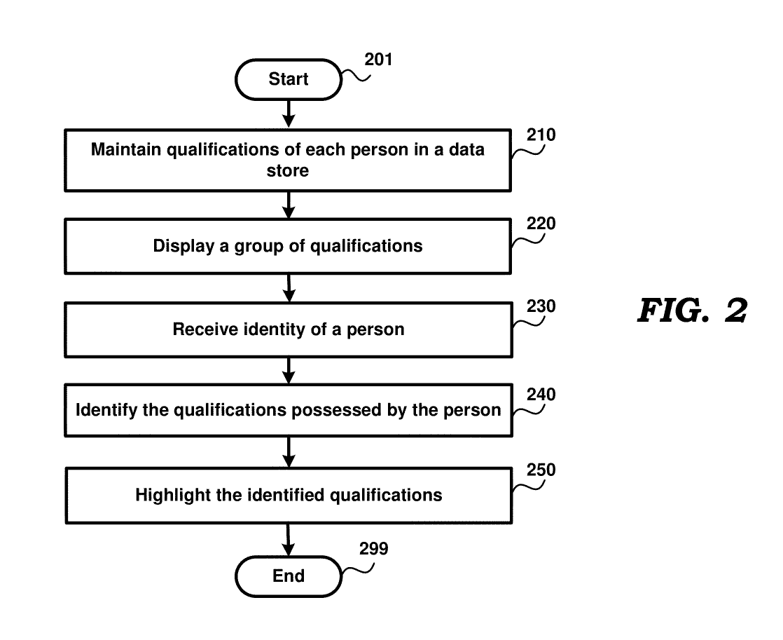

FIG. 2 is a flow chart illustrating the manner in which qualifications of people that are maintained in an ERP system may be viewed interactively, according to an aspect of the present disclosure. The flowchart is described with respect to the systems of FIG. 1 merely for illustration. However, the features can be implemented in other systems and environments also without departing from the scope and spirit of various aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 210. For ease of description, the flowchart is described in the context of end user system 110A interfacing with server system 140, even though other user systems can operate similar to user system 110A.

In step 210, server system 140 maintains the qualifications of people in data store 150. Maintaining implies one or more actions such as storing the data representing the qualifications in data store 150, retrieving of the required data when required, etc., based on appropriate interfaces consistent with the implementation of data store 150. Assuming data store 150 is implemented as a relational database server, various SQL queries may be issued by server system 140 to maintain the qualifications in data store. Information on persons and corresponding qualifications may be received based on user inputs and/or other ERP systems, etc., before being stored in data store 150.

In step 220, server system 140 sends for display a group of qualifications to a user at end user system 110A, and end user system 110A may display the received qualifications. The qualifications may be retrieved from data store 150 based on user inputs or alternatively specifically provided by the user. For example, a person's qualifications may include competencies held, degree(s) obtained, and language skills possessed. Competency refers to the extent to which a person has a specific skill or interest. The displayed group may contain any set of qualifications, though the example embodiments of below are shown displaying related qualifications in each group.

In step 230, server system 140 receives identity of a person, whose qualifications the user at end user system 110A may view. The user may specify the person of interest using any suitable mechanism, as suited for the corresponding environment. In step 240, server system 140 identifies which all of the displayed qualification of step 220 is possessed by the person selected in step 230. In doing so, server system 140 matches the selected person's qualifications (as maintained in the data store 150) with the displayed group of qualifications.

In step 250, server system 140 highlights only those set of qualifications that are possessed by the selected person amongst the group of qualifications earlier displayed. Highlighting entails making more visually conspicuous/prominent the identified set of qualifications, compared to the others of the displayed group. Highlighting may be effected by using techniques such as visually connecting the selected person/qualification with the corresponding qualification/person using lines, different colors, different shading, etc., even though other alternative techniques can be used, as will be apparent to a skilled practitioner by reading the disclosure provided herein. The highlighting of the set of qualifications is shown on the display screen of end user system 110A. The flow chart ends in step 299.

The features described above with respect to FIG. 2 can be implemented in various embodiments, as will be apparent to one skilled in the relevant arts by reading the disclosure provided herein. The description is continued illustrating the manner in which qualifications data (noted above) may be maintained in one embodiment.

### 4. Qualifications Data

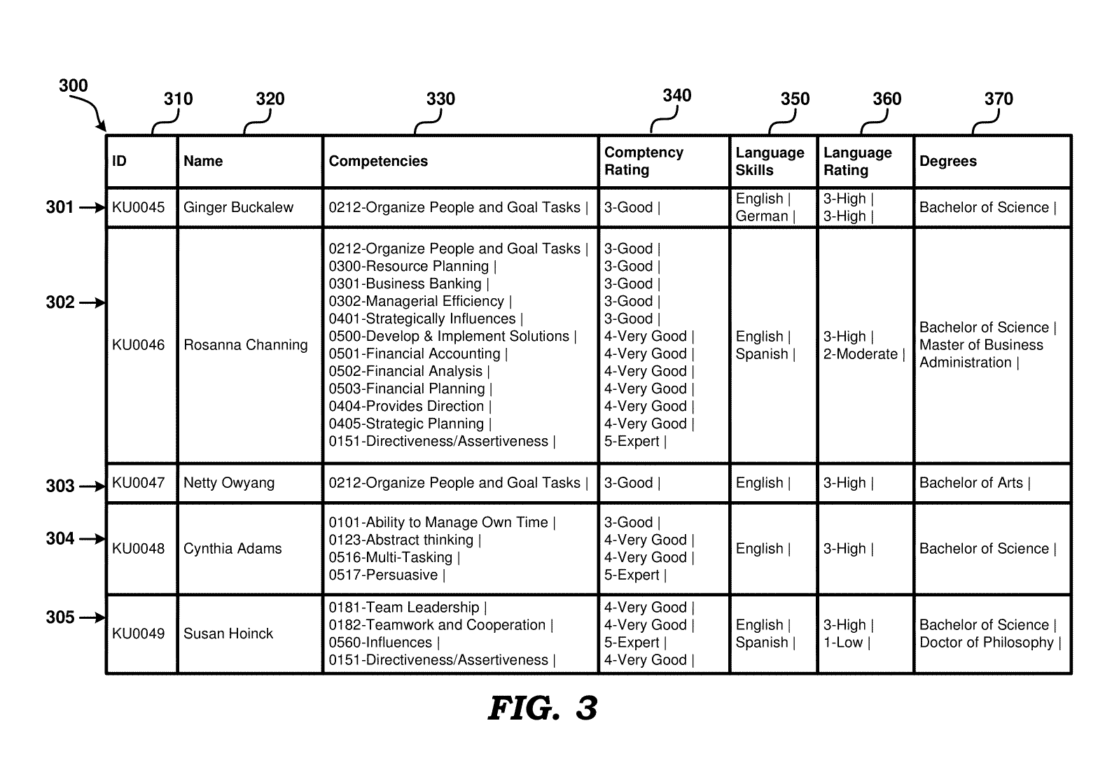

FIG. 3 illustrates the manner (logically) in which qualifications data is maintained in one embodiment. For illustration, it is assumed that data store 150 is implemented as a database server and accordingly the qualifications data is maintained in the form of table 300 in a database in the database server. However, in alternative embodiments, the qualifications data may be maintained in any other format such as XML (Extensible Markup Language) in files stored on a non-volatile memory, as will be apparent to one skilled in the relevant arts by reading the disclosure herein.

Referring to FIG. 3, table 300 depicts a portion of qualifications data maintained in data store 150. Column 310 (“ID”) specifies a unique identifier for each person. Column 320 (“Name”) specifies the name of the person associated with the unique identifier in column 310. Column 330 (“Competencies”) specifies the competencies held by the person identified in column 320. Each person may possess one or more or no (not shown) competencies. Each competency in column 330 is prefixed by a competency identifier, which is a unique ID that is assigned to the specific competency in the system. For example, persons in rows 301 and 302 hold the common competency “Organize People and Goal Tasks,” which is identified by the common ID “0212”. Column 340 (“Competency Rating”) specifies the rating assigned to the individual competency as it corresponds to the specific person holding the competency. The rating system is pre-defined in the ERP system such that a user may assign any pre-defined rating to the persons maintained in the table 300.

Column 350 (“Language Skills”) specifies the language skills possessed by the person identified in column 320. As with competencies, each person may possess one or more or none (not shown) language skills. Column 360 (“Language Rating”) specifies the rating assigned to the individual language skill as it corresponds to the specific person possessing the language skill. As with the competency rating column 340, the language skills rating system is pre-defined in the system such that a user may assign any pre-defined rating to the person's language skills maintained in the table 300. Column 370 (“Degrees”) specifies one or more or none (not shown) educational qualifications possessed by the person identified in column 320.

Data maintained in columns 330, 350 and 370 depicts a portion of qualifications data maintained in data store 150 for each person.

Each of rows 301-305 specifies the qualifications details of a corresponding person represented in the data store 150. In particular, row 301 specifies that the person named Ginger Buckalew has a competency to “Organize People and Goal Tasks” (identified by a competency identifier “0212”), in which she is rated “good” (identified by a rating scale “3”). Further, row 301 specifies that Ginger Buckalew has English and German language skills, for which she is rated with a “high” proficiency (identified by a rating scale “3”), and that she obtained a bachelors degree in science.

Thus, the qualifications data is maintained in the form of table 300 in a database in data store 150. In general, the qualifications data is maintained (access/update) by ERP applications executing in server system 140.

The description is continued with respect to example user interfaces implementing at least some of the features of the flow chart of FIG. 2 along with the data of FIG. 3.

### 5. Example User Interface

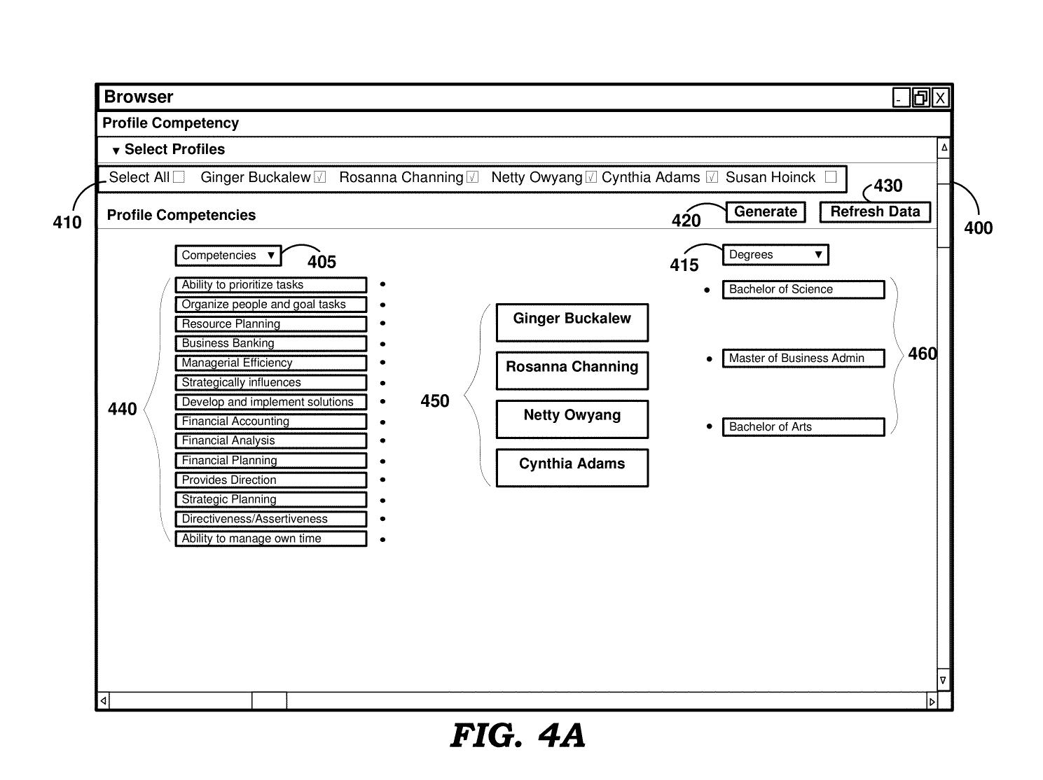

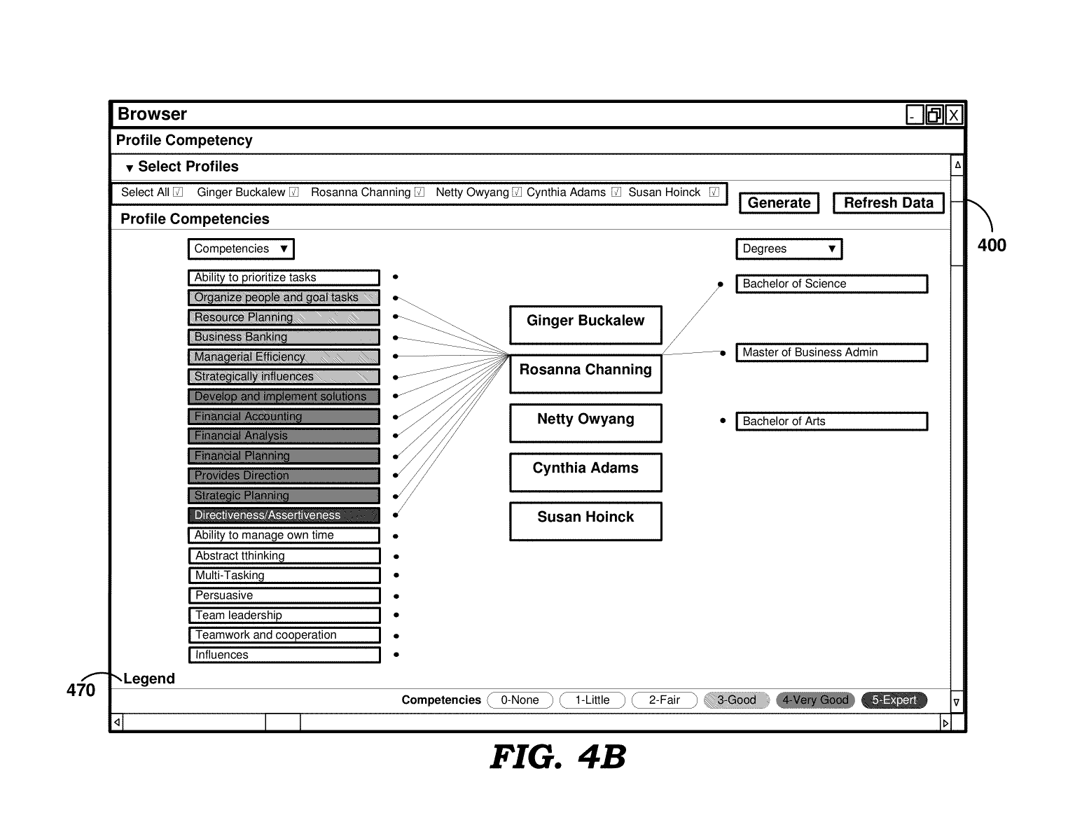

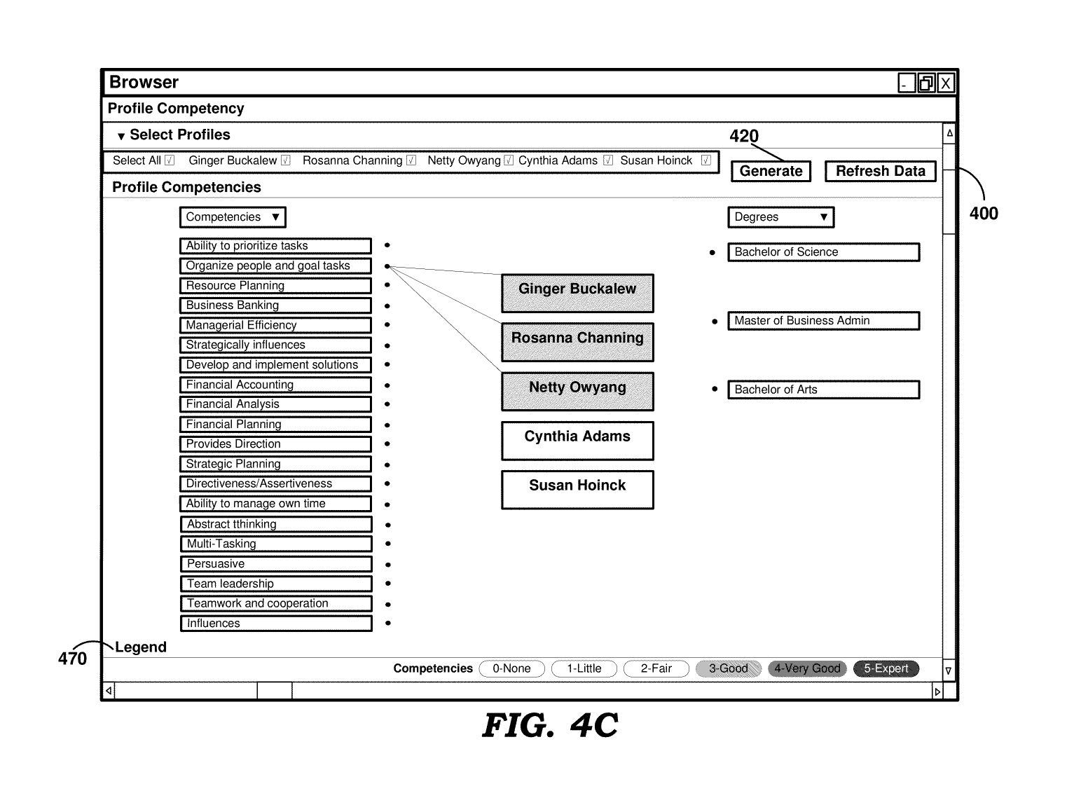

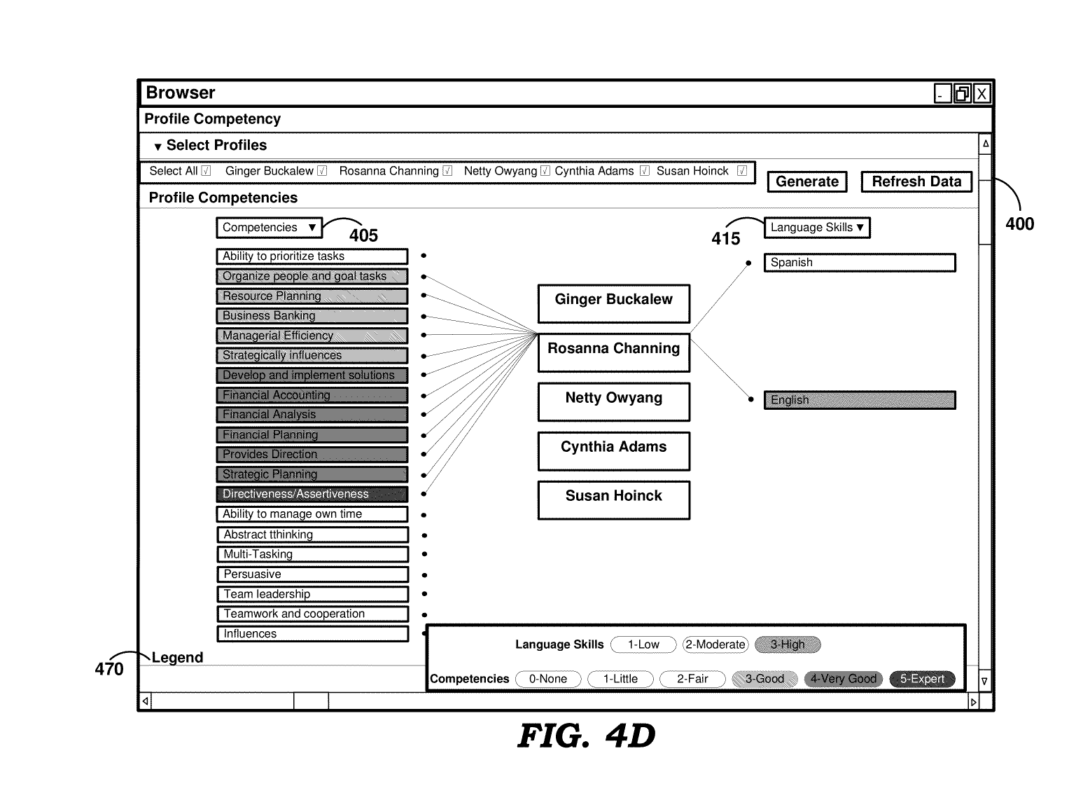

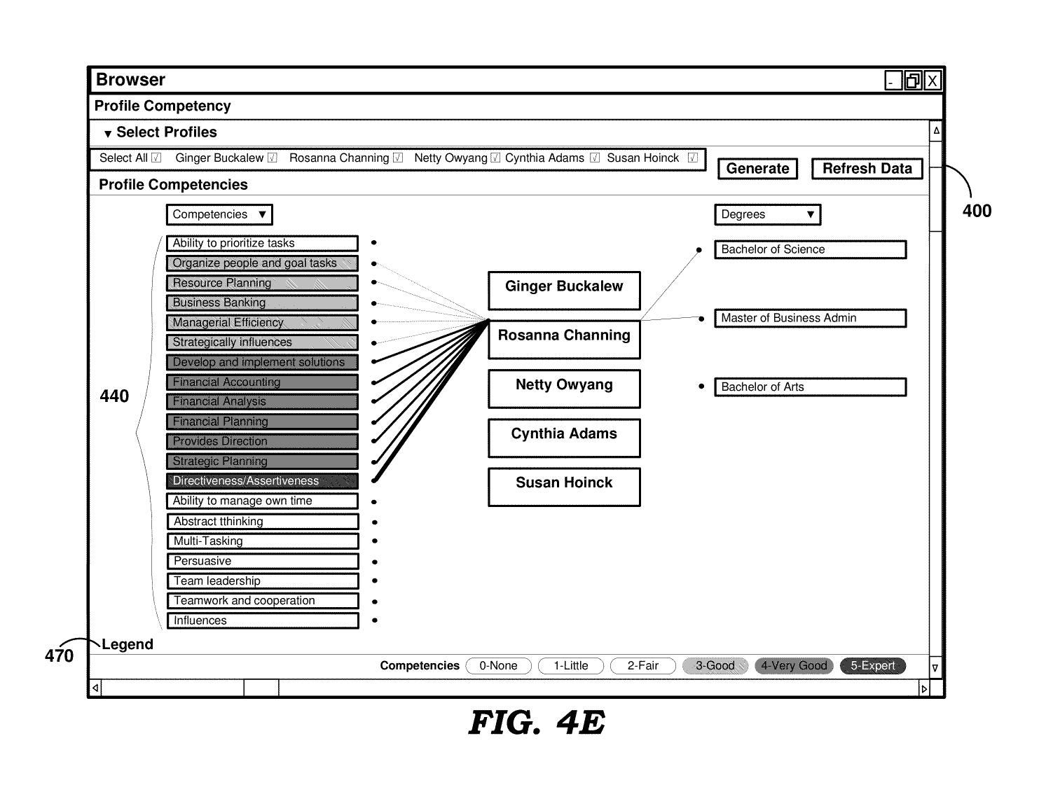

FIGS. 4A-4E and 5-7 together illustrate example user interfaces using which an ERP system visually presents qualifications of people. The Figures are described in detail below.

Referring to FIG. 4A, display area 400 depicts a portion of an ERP application's user interface that is provided on a display unit (not shown in FIG. 1) associated with end user system 110A. For ease of description, the example user interface is described in the context of end user system 110A interfacing with server system 140, even though other user systems can operate similar to end user system 110A.

Display area 400 corresponds to a webpage accessed by a user in response to sending a request to the server system 140. The webpage is received from the server system 150 prior to being displayed on the display unit.

The user begins interacting with the display area 400 by selecting one or more persons of interest in the display portion 410. For example, the persons identified in display portion 410 may be direct reports of a manager, who is the user making the selection. The user then selects the “Generate” button 420 to generate data on the selected persons. In the example shown in screen 400, all persons except Susan Hoinck are shown selected. However, the user may select a different set of persons and generate a refreshed set of data by selecting the “Refresh Data” button 430.

In response to the user clicking/selecting the “Generate” button 420, display area 400 displays three columns of data, depicted by display portions 440, 450, and 460. Display portion 450 shows persons selected in display portion 410, and display portions 440 and 460 show the qualifications of persons shown in display portion 450 for the respective groupings selected in drop-down menus 405 and 415. Each group contains a list formed by the union of all qualifications corresponding to all the persons shown selected in area 450.

In particular, ‘competencies’ and ‘degrees’ are shown as the corresponding groupings by menus 405 and 415 respectively. However, qualifications data may be shown in an ungrouped form without deviating from the scope of the present disclosure. Also, the user may choose different groupings than the ones shown on display area 400 by choosing other groupings from drop-down menus 405 and 415.

Referring to FIG. 4B, display area 400 shows an updated display when the user selects one of the persons from amongst the group of persons in display portion 450. Specifically, when the user selects (e.g., hovers a mouse on) a person “Rosanna Channing,” only those qualifications possessed by Rosanna Channing are highlighted in display portions 440 and 460. The possessed qualifications are highlighted and visually connected by using darker shading as compared to the non-possessed qualifications which remain in a non-shaded state.

Both sets of qualifications possessed by Rosanna Channing (i.e., in display portions 440 and 460) continue to be highlighted in a duration of selection, until the user selects (e.g., hovers a mouse on) another person in the display portion 450. Once selection of a person is complete, the selection is deemed to be effective for a duration until the next selection is received. Although not shown, if the selected person has no qualifications in a certain group, e.g., no degrees, none of the qualifications in that group would be highlighted.

FIG. 4B also shows legend 470 defining qualification ratings that appear in the display area 400. Legend 470 is dynamically generated for each group of qualifications that have a corresponding rating system in data store 150. For example, as shown in FIG. 3, data store 150 maintains ratings data for competency and language skills, but not for degrees. Thus, legend 470 generated and shown in display portion 470 only pertains to competencies.

Thus, when the user selects a person from the list of persons in display portion 450, in addition to highlighting the qualifications possessed by the selected person, display area 400 also shows the person's rating (extent to which qualification is satisfied) for each qualification for which a rating is available. The rating for each qualification is shown by matching the background color of the qualification with the corresponding texture/color of the rating in legend 470. For example, for the qualification “Directiveness/Assertiveness,” the selected person Rosanna Channing possessed an “5-Expert” rating, and the same is reflected by highlighting her qualification in a dark shade background, matching the dark shade background shown for “5-Expert” in legend 470.

Further, when viewing the qualifications for another person (e.g., Susan Hoinck) with a lower rating (e.g., 4-Very Good) in the same qualification (Directiveness/Assertiveness), Rosanna Channing's qualification would be displayed more prominently than Susan Hoinck's qualification, e.g., by using a lighter shade background that matches the background shown for “4-Very Good,” than the dark shade background used for Rosanna Channing.

Referring to FIG. 4C, display area 400 shows an updated display when the user selects one of the qualifications from amongst the group of qualifications in display portion 440. Specifically, when the user selects a qualification “Organize people and goal tasks,” only those persons who possess the selected qualification are highlighted in display portion 450. Those persons (e.g., Cynthia Adams and Susan Hoinck) who do not possess the selected qualification would not be highlighted.

As described above with reference to the highlighting of qualifications in FIG. 4B, when the user selects a qualification from the list of qualifications in display portion 440, in addition to highlighting the persons who possess the selected qualification, display area 400 also shows the person's rating (extent to which the person satisfies the selected qualification) for each qualification for which a rating is available. Each person's rating for the corresponding qualification is shown by matching the background color of the person with the corresponding color of the rating in legend 470. For example, for the qualification “Organize people and goal tasks,” the selected persons Ginger Buckalew Rosanna Channing, and Netty Owyang, all possessed a “3-Good” rating, and the same is reflected by highlighting them in a medium shade background, matching the medium shade background shown for “3-Good” in legend 470.

Referring to FIG. 4D, display screen 400 shows the qualifications being grouped by competencies as well as language skills. As described earlier, a user may choose different groupings of qualifications by choosing from the list of groupings in drop-down menus 405 and 415. As shown in this figure, the user chose Language Skills as the group of qualifications in column 460.

Legend 470 now shows ratings for both competencies as well as language skills, as language skills (unlike “degrees” in FIG. 4B) has a rating system associated with it. Like the rating for competencies, the rating for each language is shown by matching the background color of the language (highlighted for the person selected) with the corresponding color of the rating in legend 470. For example, for the language skill “English,” the selected person Rosanna Channing possessed an “3-High” rating, and the same is reflected by highlighting her English language qualification in a dark shade background, matching the dark shade background shown for “3-High” in legend 470.

Referring to FIG. 4E, another way of showing a person's qualification rating is disclosed. As described above, the extent to which a person satisfies a selected qualification may be shown by matching the background texture/color of the person with the corresponding color of the rating in legend 470. FIG. 4E shows the use of different styles of lines to highlight the extent to which a person satisfies a selected qualification.

Specifically, when the user selects (e.g., hovers a mouse on) a person “Rosanna Channing,” the extent to which Rosanna Channing satisfies each qualification in the set of qualifications possessed by her are shown using different styles of lines. The dotted lines from Rosanna Channing to the qualifications in column 440 show that she had a “Good” rating in the corresponding qualifications. The solid lines from Rosanna Channing to the qualifications in column 440 show that she had a “Very Good” rating in the corresponding qualifications. The dark solid line from Rosanna Channing to the qualification in column 440 shows that she had an “Expert” rating in that qualification.

Thus, users can view the style of lines in addition to/or along with the shading/colors of a qualification to understand the extent to which the selected person satisfies the corresponding qualification, without having to necessarily refer to the legend to obtain such information.

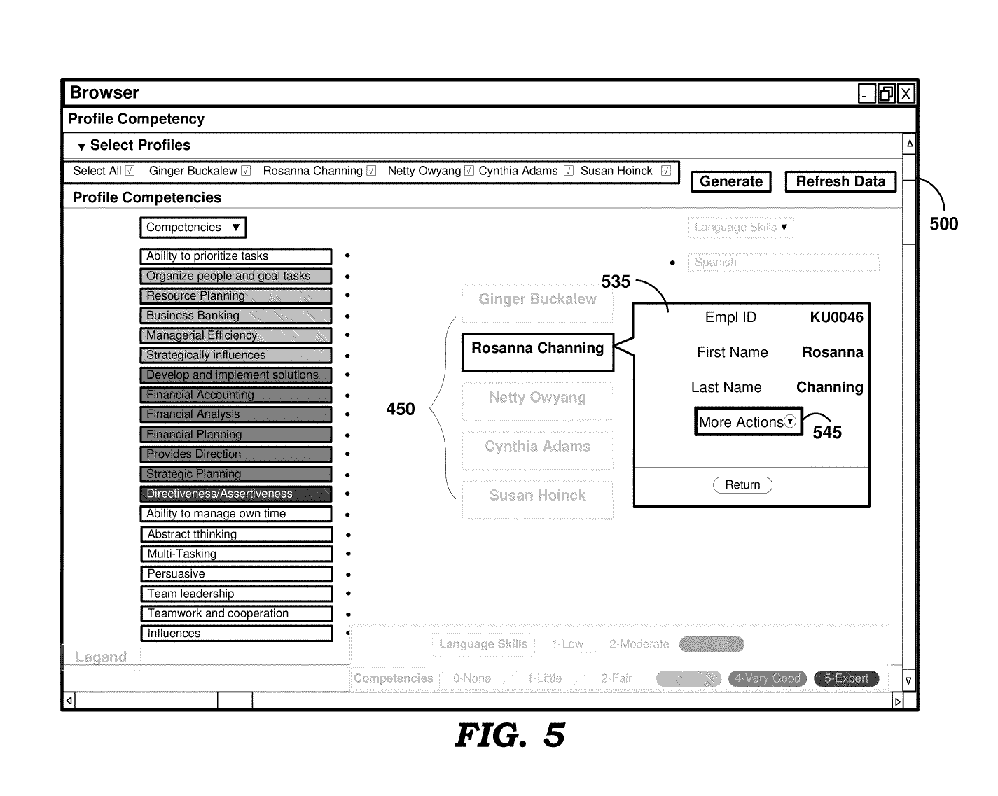

Referring to FIG. 5, display screen 500 shows the user selecting one of the persons in display portion 450 (e.g., by a single click to the person's name). Upon the user selecting the person, an additional information screen 535 is shown. Additional information screen 535 may contain any type of data related to the selected person that is stored in data store 150. Here, additional information screen 535 shows the selected person's name and employee ID, previously shown as being stored in table 300 of FIG. 3. The user may then choose to perform additional actions on the selected person by selecting (e.g., by clicking on) the “More Actions” button 545.

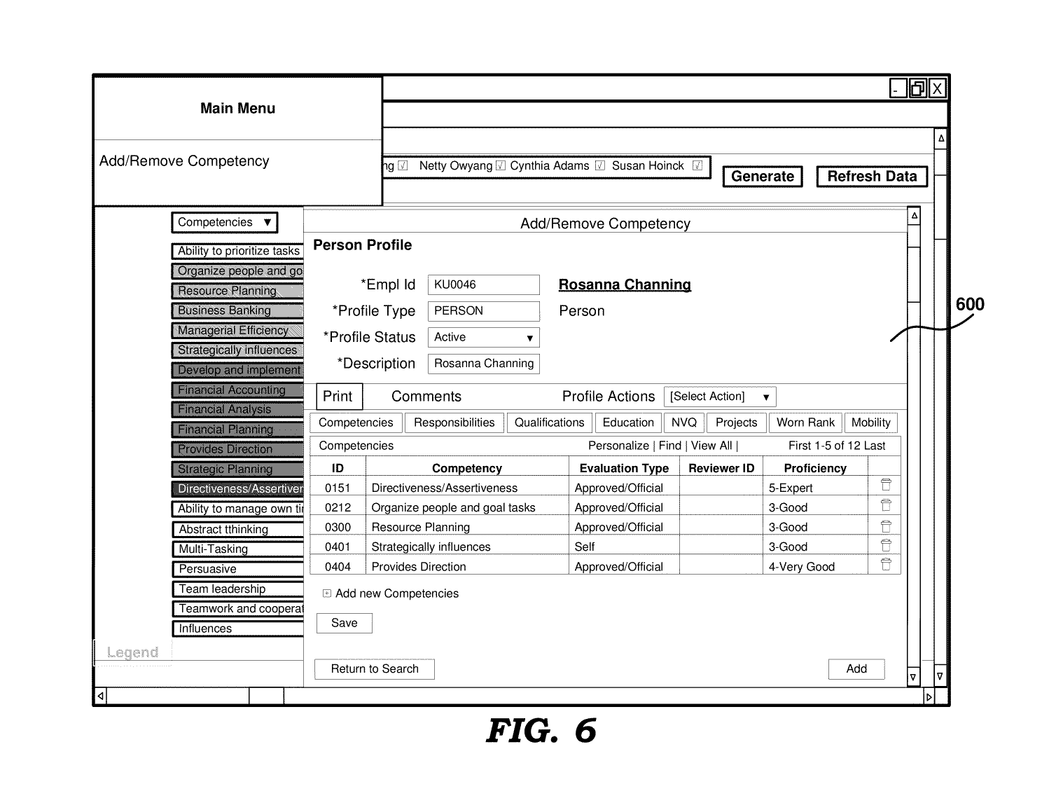

Referring to FIG. 6, display screen 600 shows the screen that is displayed to the user when the user selects to perform “More Actions” on a selected person, as shown in FIG. 5. In display screen 500, the user may view the selected person's qualifications, along with some of the information shown previously in the additional information screen 535, such as the name and the employee ID. On this screen, the user is able to both view and update the various qualifications shown for the selected person. Any changes to the information presented on this screen will be saved in the data store 150, by updating the corresponding database table (e.g., table 300 of FIG. 3).

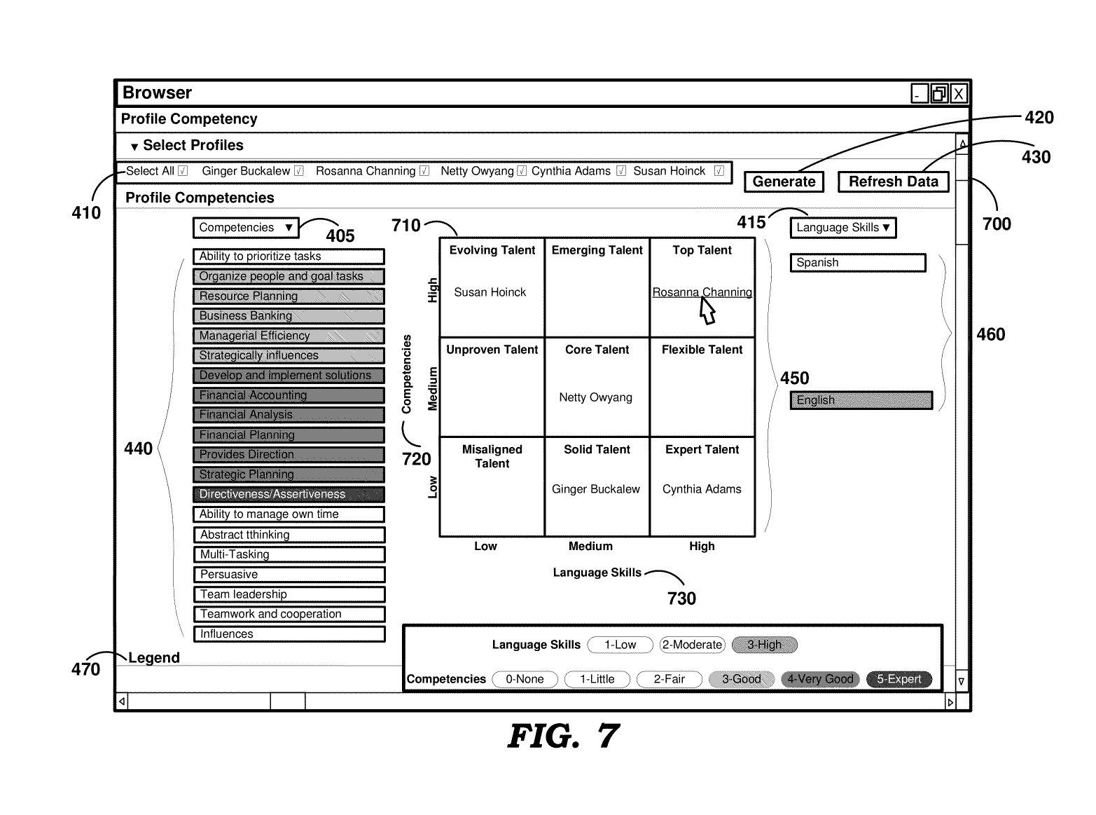

Referring to FIG. 7, another way of showing the relationship between a person and their possessed qualifications is disclosed. The user begins interacting with the display area 700 by selecting one or more persons of interest in the display portion 410. The user then selects the “Generate” button 420 to generate data on the selected persons. In the example shown in screen 700, all persons are shown selected. However, the user may select a different set of persons and generate a refreshed set of data by selecting the “Refresh Data” button 430.

In response to the user clicking/selecting the “Generate” button 420, display area 700 displays three columns of data, depicted by display portions 440, 450, and 460. Display portion 450 shows persons selected in display portion 410, and display portions 440 and 460 show the qualifications of persons shown in display portion 450 for the respective groupings selected in drop down menus 405 and 415. Each group in columns 440 and 460 contains a list formed by the union of all qualifications corresponding to all the persons shown selected in display portion 450. In particular, ‘competencies’ and ‘language skills’ are shown as the corresponding groupings by menus 405 and 415 respectively.

Unlike FIGS. 4A-4E, column 450 of FIG. 7 shows the selected persons in a graph format. Graph 710 shows two dimensions 720 and 730, each tied to corresponding groupings of qualifications in drop-down menus 405 and 415 respectively. Specifically, dimension 720 is tied to (i.e., associated with) the qualifications group “competencies” and dimension 730 is tied to qualifications group “language skills.”

In one implementation, graph 710 may be designed such that for each dimension, there are three scales shown, “Low”, “Medium” and “High.” Each scale is assigned a minimum and maximum threshold number that may be generated dynamically during the rendering of the graph. For example, in the example of FIG. 7, the union of all selected persons shows two language skills, English and Spanish, with each language having a minimum rating of 1 (low) and a maximum rating of 3 (high), with a value of 0 indicating that the corresponding qualification is not possessed. Thus, for this group of selected persons, the maximum threshold number for the language skills dimension 730 would be 6, calculated as the sum of the maximum ratings for each of the two languages shown. The minimum threshold number would be 2, calculated as the sum of the minimum ratings for each of the two languages shown. Thereafter, the low, medium and high scales may be dynamically assigned such that any selected person whose combined rating for the two languages is within the top ⅓^{rd} of the maximum threshold number (i.e., 5 and 6) would be placed in the “High” scale, within the middle ⅓^{rd} (i.e., 3 and 4) would be placed in the “Medium” scale, and within the bottom ⅓^{rd} (i.e., 1 and 2) would be placed in the “Low” scale.

In case of competencies grouping 405, there are many more qualifications. Similar numerical approach may be employed to place each person of interest in one of Low, Medium and High scales. The final placement of each person on graph 710 would be the meeting point of their placement with respect to dimensions 720 and 730, as will be apparent to one skilled in the relevant arts by reading the disclosure provided herein.

The graph is rendered in an n-box (here 9) format, where each box displays a pre-assigned label. Specifically, graph 710 shows 9 boxes with labels “Misaligned Talent”, “Solid Talent”, “Expert Talent”, “Unproven Talent”, “Core Talent”, “Flexible Talent”, “Evolving Talent”, “Emerging Talent”, and “Top Talent.” The labels may be pre-assigned to graph 710 such that each time graph 710 is rendered, it would display the same set of labels for any group of qualifications.

Additionally, similar to the implementation shown with respect to FIGS. 4A-4D, when the user selects (e.g., hovers a mouse on) a person (e.g., Rosanna Channing) only those qualifications possessed by Rosanna Channing are highlighted in display portions 440 and 460.

The user interfaces described above with respect to FIGS. 4A-7 can be implemented with different levels of interactivity between server system 140 and end user system 110A. In one embodiment, end user system 110A may be implemented to receive a non-scripted web page and the display in each screen of FIG. 4A-7 can be received from server system 140 as a corresponding web page, and displayed on a display screen associated with end user system 110A. In such an embodiment, at least some of the steps of FIG. 2 may be performed by the processor(s) executing in the end user systems, as described below.

In an alternative embodiment, server system sends webpages with appropriate content using D3.js (Data Driven Documents, a Java Script function library) such that the interactive user interfaces provided at end user system 110A (as depicted in FIGS. 4A-7) is supported with minimal packet exchange on Internet 120. For example, to generate the web page of FIG. 4A, server system 140 examines the content of data store 150 to provide the entire list of persons shown in area 410 along with their qualifications for the selected qualification groupings. Upon user selecting the desired persons as shown at 450, and clicking on “Generate” button 420, a scripted web page is generated including the various displayed qualifications, etc., which web page may thereafter provide the interfaces of FIGS. 4B-4E, and 7 etc.

In one implementation, a complete list of persons (e.g., all direct reports of a manager or the user making the selection) and their qualifications for any two qualification groupings configured as defaults are retrieved upfront when the webpage of FIG. 4A is first loaded. Subsequently, upon user selecting a sub-set of the persons from the complete list, and clicking on generate “Generate” button 420, the updated set of persons and their corresponding qualifications is regenerated on the webpage without any interaction from the server system 140, since all the data (i.e., persons and their qualifications) is already available on the end user system 110A.

However, upon user changing one (or both) qualification groupings, and clicking the “Refresh Data” button 430, a new request for data is sent to server system 140. Server system 140 examines the content of data store 150 to generate the webpage of FIG. 4A and to provide the list of persons selected along with their qualifications for the newly selected qualification groupings on the webpage.

In one implementation, where the display of persons and their qualifications is designed in the context of a user who is a manager, when the webpage is first loaded, the list of persons shown is defaulted to be a list of all direct reports for the concerned manager. However, in other embodiments, the list of persons displayed could be dynamically prompted from the available employees/persons of interest in the ERP database (e.g., applicants for a job for recruiting, list of possible candidates for succession planning, and a list of learners for enterprise learning management), as suited for the corresponding environment.

However, when the user selects a specific person of interest, end user system 110A may provide the updated display of FIGS. 4B/4D, without having to communicate with server system 140 since the corresponding data is already available at end user system 110A. It may be appreciated that the web page received at FIG. 4A contains the scripts (in general, program logic) to be able to generate the interfaces of FIGS. 4B-4E and FIG. 7, without having to communicate with server system 140. However, alternative embodiments can be implemented with the web pages being designed to require more communication with server system 140, upon various user interactions.

It should be appreciated that the features described above can be implemented in various embodiments as a desired combination of one or more of hardware, executable modules, and firmware. The description is continued with respect to an embodiment in which various features are operative when executable modules are executed.

### 6. Digital Processing System

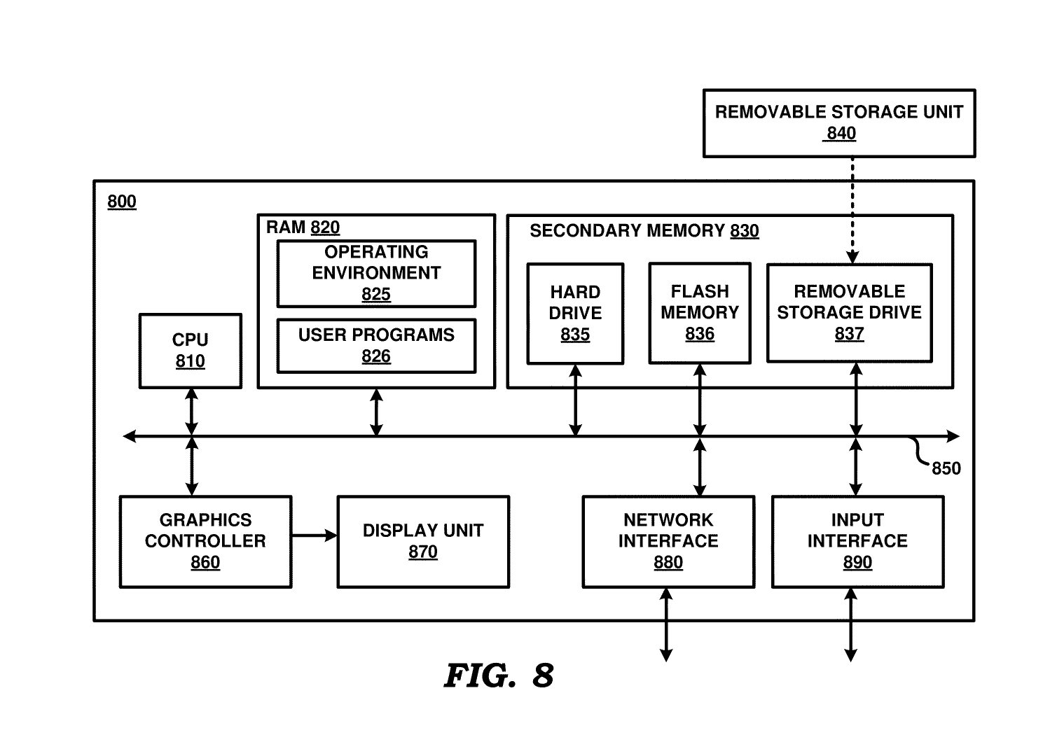

FIG. 8 is a block diagram illustrating the details of digital processing system 800 in which various aspects of the present disclosure are operative by execution of appropriate executable modules. Digital processing system 800 may correspond to server system 140 or end user system 110A.

Digital processing system 800 may contain one or more processors such as a central processing unit (CPU) 810, random access memory (RAM) 820, secondary memory 830, graphics controller 860, display unit 870, network interface 880, and input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present disclosure. CPU 810 may contain multiple processing units, with each processing unit potentially being designed for a specific task. Alternatively, CPU 810 may contain only a single general-purpose processing unit.

RAM 820 may receive instructions from secondary memory 830 using communication path 850. RAM 820 is shown currently containing software instructions constituting shared environment 825 and/or other user programs 826 (such as analytical applications, etc.). Shared environment 825 may contain software programs such as device drivers, virtual machines, etc., which provide a (common) run time environment for execution of the user programs.

Graphics controller 860 generates display signals (e.g., in RGB format) to display unit 870 based on data/instructions received from CPU 810. Display unit 870 contains a display screen to display the images defined by the display signals. Input interface 890 may correspond to a keyboard and a pointing device (e.g., touch-pad, mouse) and may be used to provide inputs. Network interface 880 provides connectivity to a network (e.g., using Internet Protocol), and may be used to communicate with other systems connected to the network (110, 140 and 150 of FIG. 1).

Secondary memory 830 may contain hard drive 835, flash memory 836, and removable storage drive 837. Secondary memory 830 may store the data (for example, portions of the qualifications) and software instructions (for implementing the steps of FIG. 2), which enable digital processing system 800 to provide several features in accordance with the present disclosure. The code/instructions stored in secondary memory 830 may either be copied to RAM 820 prior to execution by CPU 810 for higher execution speeds, or may be directly executed by CPU 810.

Secondary memory 830 may contain hard drive 835, flash memory 836, and removable storage drive 837. Some or all of the data and instructions may be provided on removable storage unit 840, and the data and instructions may be read and provided by removable storage drive 837 to CPU 810. Removable storage unit 840 may be implemented using medium and storage format compatible with removable storage drive 837 such that removable storage drive 837 can read the data and instructions. Thus, removable storage unit 840 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 840 or hard disk installed in hard drive 835. These computer program products are means for providing software to digital processing system 800. CPU 810 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 830. Volatile media includes dynamic memory, such as RAM 820. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 850. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 7. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method implemented at least in part in a digital processing system, said method comprising:
sending a group of qualifications for display on a display screen;
receiving identity of a person;
identifying a set of qualifications possessed by said person, wherein said set of qualifications are contained in said group of qualifications; and
highlighting on said display screen said set of qualifications,
wherein said identifying and highlighting are performed in response to said receiving.

2. The method of claim 1, wherein said set of qualifications contains a first qualification, and said group of qualifications contains a second qualification that is not contained in said set of qualifications,
wherein said highlighting highlights said first qualification but not said second qualification.

3. The method of claim 2, wherein said highlighting comprises visually connecting said person on said display to each of said set of qualifications,
wherein said person is connected to said first qualification but not said second qualification in said display on said display screen.

4. The method of claim 1, wherein said method further comprises:
sending for display a plurality of persons including said person, wherein said plurality of persons are displayed along with said group of qualifications in said display on said display screen,
wherein said receiving comprises receiving a selection of said person on said display screen from amongst said group of persons displayed.

5. The method of claim 4, wherein said person is selected as a first person in a first duration and then a second person is selected in a second duration, wherein both of said first person and said second person possess a third qualification,
said method further comprising determining an extent to which said third qualification is satisfied by each of said first person and said second person, wherein said third qualification is determined to be satisfied to a greater extent by said second person than said first person, said second person being contained in said plurality of persons,
wherein said highlighting highlights said relationship of second person to said third qualification visually more prominently in said second duration than relationship of said first person to said third qualification in said first duration.

6. The method of claim 4, wherein said method further comprises:
sending for display a plurality of groups of qualifications on said display screen, said plurality of groups including said group as a first group of qualifications, in addition to a second group of qualifications,
wherein said first group contains a first plurality of qualifications and said second group contains a second plurality of qualifications,
in response to receiving of said identity of said person, said identifying further identifying a second set of qualifications of said second plurality of qualifications possessed by said person,
wherein said highlighting highlights both of said set of qualifications and said second set of qualifications in a duration of selection of said person on said display screen.

7. The method of claim 6, wherein said method further comprises receiving selection of a fourth qualification from said first plurality of qualifications displayed on said display screen,
in response to receiving of selection of said fourth qualification:
identifying a fourth person and a fifth person of said plurality of persons, as possessing said fourth qualification; and
highlighting said fourth person and said fifth person on said display in a duration of selection of said fourth qualification.

8. The method of claim 1, wherein said digital processing system is a server system.

9. A non-transitory machine readable medium storing one or more sequences of instructions for enabling a server system to provide interactive interface for viewing of qualifications of a person, wherein execution of said one or more instructions by one or more processors contained in said system enables said system to perform the first actions of:
generating a web page and sending said web page and a group of persons to an end user system, wherein rendering of said page at said end user system enables the second actions of:
displaying said group of persons on a display screen of said end user system;
receiving identity of a qualification;
identifying a set of persons possessing said qualification, wherein said set of persons are contained in said group of persons; and
highlighting on said display screen said set of persons,
wherein said identifying and highlighting are performed in response to said receiving.

10. A non-transitory machine readable medium storing one or more sequences of instructions for enabling a server system to provide interactive interface for viewing of qualifications of a person, wherein execution of said one or more instructions by one or more processors contained in said system enables said system to perform the first actions of:
generating a web page and sending said web page and a group of qualifications to an end user system, wherein rendering of said page at said end user system enables the second actions of:
displaying said group of qualifications on a display screen of said end user system;
receiving identity of a person;
identifying a set of qualifications possessed by said person, wherein said set of qualifications are contained in said group of qualifications; and
highlighting on said display screen said set of qualifications,
wherein said identifying and highlighting are performed in response to said receiving.

11. The non-transitory machine readable medium of claim 10, wherein said set of qualifications contains a first qualification, and said group of qualifications contains a second qualification that is not contained in said set of qualifications,
wherein said highlighting highlights said first qualification but not said second qualification.

12. The non-transitory machine readable medium of claim 11, wherein said highlighting comprises visually connecting said person on said display to each of said set of qualifications,
wherein said person is connected to said first qualification but not said second qualification in said display on said display screen.

13. The non-transitory machine readable medium of claim 10, wherein said second actions further comprise:
sending for display a plurality of persons including said person, wherein said plurality of persons are displayed along with said group of qualifications in said display on said display screen,
wherein said receiving comprises receiving a selection of said person on said display screen from amongst said group of persons displayed.

14. The non-transitory machine readable medium of claim 13, wherein said person is selected as a first person in a first duration and then a second person is selected in a second duration, wherein both of said first person and said second person possess a third qualification,
said second actions further comprising determining an extent to which said third qualification is satisfied by each of said first person and said second person, wherein said third qualification is determined to be satisfied to a greater extent by said second person than said first person, said second person being contained in said plurality of persons,
wherein said highlighting highlights said relationship of second person to said third qualification visually more prominently in said second duration than relationship of said first person to said third qualification in said first duration.

15. The non-transitory machine readable medium of claim 13, wherein said second actions further comprise:
sending for display a plurality of groups of qualifications on said display screen, said plurality of groups including said group as a first group of qualifications, in addition to a second group of qualifications,
wherein said first group contains a first plurality of qualifications and said second group contains a second plurality of qualifications,
in response to receiving of said identity of said person, said identifying further identifying a second set of qualifications of said second plurality of qualifications possessed by said person,
wherein said highlighting highlights both of said set of qualifications and said second set of qualifications in a duration of selection of said person on said display screen.

16. The non-transitory machine readable medium of claim 15, wherein said second actions further comprise receiving selection of a fourth qualification from said first plurality of qualifications displayed on said display screen,
in response to receiving of selection of said fourth qualification:
identifying a fourth person and a fifth person of said plurality of persons, as possessing said fourth qualification; and
highlighting said fourth person and said fifth person on said display in a duration of selection of said fourth qualification.

17. The non-transitory machine readable medium of claim 15, wherein said plurality of persons are displayed on a graph having a plurality of dimensions, wherein each dimension is uniquely tied to one of said plurality of groups,
wherein each person is placed on a corresponding location of said graph such that the location on each dimension indicates the extent to which the person satisfies the corresponding group of qualifications.

18. The non-transitory machine readable medium of claim 17, wherein a first dimension of said plurality of dimensions corresponds to a first group, said first group containing a plurality of competencies as respective qualifications,
wherein each person is placed on a location of said first dimension determined by the extent to which the person satisfies said plurality of competencies,
wherein said identity of said person is received upon selection of the person on said graph.

19. A computing system comprising:
a server system to send a web page, said server system also sending a plurality of persons and a plurality of groups, wherein each group contains a corresponding plurality of qualifications; and
an end user system to receive said web page and render said web page on a display screen of said end user system, wherein rendering of said web page enables said end user system to perform the actions of:
displaying said plurality of persons and said plurality of groups on said display screen;
receiving identity of a person;
identifying a set of qualifications possessed by said person, wherein said set of qualifications are contained in said groups of qualifications; and
highlighting on said display screen said set of qualifications,
wherein said identifying and highlighting are performed in response to said receiving.

20. The computing system of claim 19, said actions further comprising:
receiving identity of a qualification;
identifying a set of persons possessing said qualification, wherein said set of persons are contained in said plurality of persons; and
highlighting on said display screen said set of persons,
wherein said identifying and highlighting are performed in response to said receiving of said identity of said qualification.
